(19) United States
(12) Patent Application Publication
(10) Pub. No.: US 2015/0287329 A1
(43) Pub. Date: Oct. 8, 2015

(54) Integrated Touch Desk System

(71) Applicant: Edward J. Bevenour, JR., Harleysville, PA (US)

(72) Inventor: Edward J. Bevenour, JR., Harleysville, PA (US)

(21) Appl. No.: 14/664,943

(22) Filed: Mar. 23, 2015

Related U.S. Application Data
(60) Provisional application No. 61/974,461, filed on Apr. 3, 2014.

(51) Int. Cl. G09B 5/02; A47B 21/04; G09B 19/00; G02B 21/00; H04N 7/18; H04N 5/232; A47B 41/00; H04L 29/06

(52) U.S. Cl. CPC G09B 5/02; A47B 41/00; A47B 21/04; H04L 63/08; H04L 63/105; G02B 21/008; H04N 7/183; H04N 5/23216; H04N 5/23219; G09B 19/00

(57) ABSTRACT

An integrated desk system is provided. The desk system includes an electronic network. A plurality of student desks are connected to the electronic network. Each of the plurality of student desks has a student touchscreen. Each student touchscreen includes a plurality of displays. Each of the plurality of student desks has access to only others of the plurality of student desks. A teacher desk is connected to the electronic network. The teacher desk has a teacher touchscreen and access only to each of the plurality of student desks. An administrator desk is connected to the electronic network. The administrator desk has access to the teacher desk and each of the plurality of student desks.

### CROSS-REFERENCE TO RELATED APPLICATION

The present application claims the benefit of U.S. Provisional Patent application Ser. No. 61/974,461, filed on Apr. 3, 2014, which is incorporated by reference herein in its entirety.

### FIELD OF THE INVENTION

The present invention relates to a classroom desk having a desktop into which a touch screen is integrated. Each desk in connected to a network to enable file sharing, communications and other interaction among a plurality of the inventive desks.

### BACKGROUND OF THE INVENTION

Electronic communications today allow for remote learning via an electronic network, such as, for example, the Internet. In this matter, students who are not physically present in a classroom can participate in the class.

It would be beneficial to provide an electronic network within the classroom that allows the students who are in the class to communicate with and share files with each other.

### BRIEF SUMMARY OF THE INVENTION

Briefly, the present invention provides an integrated desk system. The desk system includes an electronic network. A plurality of student desks are connected to the electronic network. Each of the plurality of student desks has a student touchscreen. Each student touchscreen includes a plurality of displays. Each of the plurality of student desks has access to only others of the plurality of student desks. A teacher desk is connected to the electronic network. The teacher desk has a teacher touchscreen and access to each of the plurality of student desks. An administrator desk is connected to the electronic network. The administrator desk has access to the teacher desk and each of the plurality of student desks.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic top level view of a first exemplary embodiment an integrated electronic desk system of the present invention;

FIG. 2 is a flowchart illustration an exemplary operation of the electronic desk system of FIG. 1;

FIG. 3 is a top plan view of an exemplary Graphical user Interface (GUI) of a teacher's desk in the electronic desk system according to the present invention;

FIG. 4 is a schematic view showing the electronic connections of a plurality of student desks assigned in group using the system of the present invention; and

FIG. 5 is a top plan view of an exemplary GUI of a student's desk in the electronic desk system according to the present invention.

### DETAILED DESCRIPTION OF THE INVENTION

In the drawings, like numerals indicate like elements throughout. Certain terminology is used herein for convenience only and is not to be taken as a limitation on the present invention. As used herein, a “desk” refers to a user interface device, and not necessarily a physical desk at which a person typically sits. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Referring to the Figures in general, an integrated touch desk system 100 according to an exemplary embodiment of the invention is shown. System 100 may be used in school environment to facilitate teaching as well as administration of the physical functions. Students, teachers, and school administrators will be able to access system 100 and electronically transmit files and other information to each other, subject to specific permissions, via system 100.

System 100 can be used by several different types of users, each with the ability to view and operate system 100 in separate ways. For example, system 100 may have different permission levels for students, parents, teachers, and administrators. In one example, parents may have the lowest level of access and then students, then teachers, with administrators having the highest level of access.

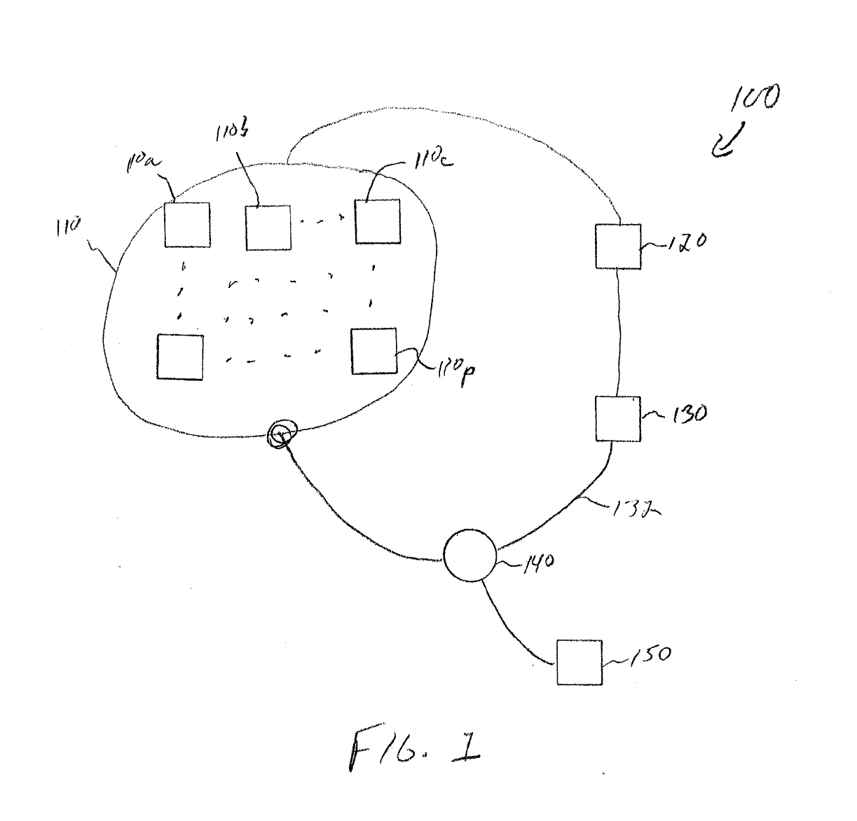

A schematic drawing of system 100 is shown FIG. 1. Student, or lower level, desks 110a-110n will be collectively referred to as student desks 110. Student desks 110 may be connected to a teacher, or upper level, desk 120 and an administrator desk or network server 130 via an in-school intranet 132. Additionally, an exterior Internet connection 140 may be available to transmit information and communicate between the intranet and an outside party 150, such as a parent or a student who may be absent from school and working from a remote location, such as, for example, his home.

Different authorization levels allow different users to use the desks of different types of users. For example, a teacher may be able to use the student desk 110 and an administrator may be able to use a student desk 110 or a teacher desk 120, but a teacher would not be able to use an administrator desk 130 and a student would not be able to use a teacher desk 120 or an administrator desk 130.

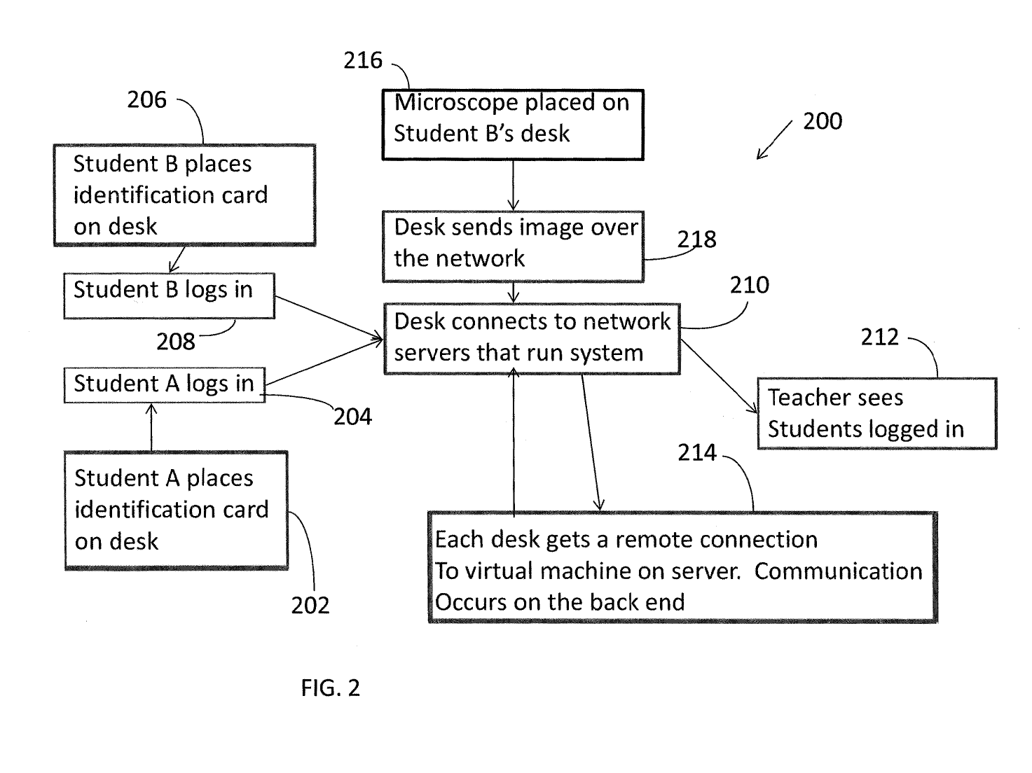

In order to be authorized to use a desk 110, 120, 130, a user must first log in or sign onto the desk. Referring to flowchart 200 in FIG. 2, in step 202, a first student places his/her identification card on desk 110a in order to authenticate himself/herself and login. Authentication can take place using near field communication, an identification card with wireless communication, such as radio frequency identification (RFID), or other known or as yet unknown method. While an identification card can be used to authenticate a particular student, those skilled in the art will recognize that other types of authentication methods, such as, using fingerprints, retinal scans, or other biometric or other types of identification can be used. In step 204, desk 110a reads the information on the identification card and logs in the first student at desk 110a. Similarly, in steps 206, 208, a second student places his/her identification card on desk 110b and desk 110b reads the information on the identification card and logs in the second student at desk 110b. Desks 110a and 110b connect to network server 130 in step 210.

Depending on the physical location of the desks 110a, 11b, the visual attributes and capabilities of desk 110a, 110b may vary. For example, if the students login in the science room, then only features related to the students' science class may be available. Using desk 120, a teacher, however, may be able to override this restriction and allow a student to access other features not necessarily related to science class.

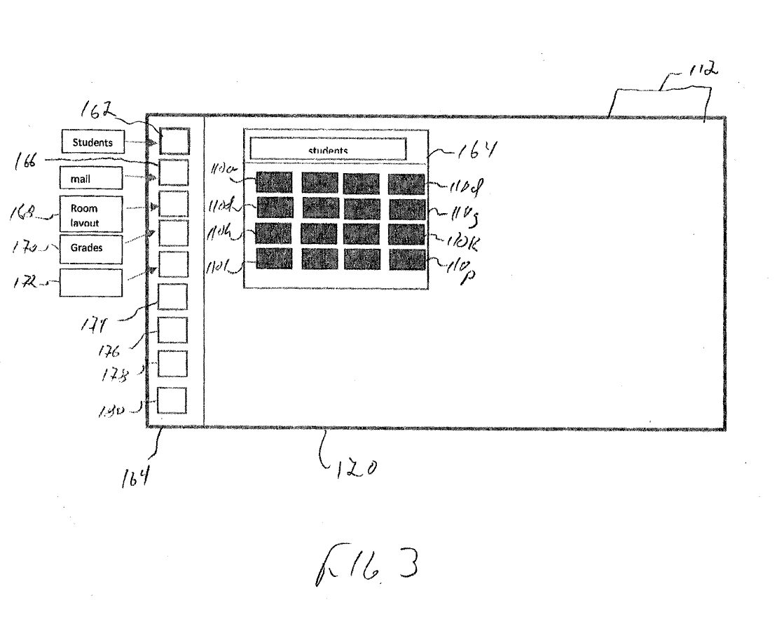

As each student logs in at a desk 110, the teacher can see, in step 212, which students have logged in. The teacher desk 120, shown in FIG. 3, provides a “students” icon 162 that can be clicked on to generate an overhead view 164 of all student desks 110a-110p. Desks 110a-110p at which a student has logged in change color or provide some other visual differentiation from desks 110a-110p at which students have not yet logged in.

In step 214, each desk 110, 120 that is logged in to system 100 has window rendering and thin client attributes. Each desk 110, 120 gets a remote connection to a virtual machine of server 130 in order to speed communications between desks 110, 120. All communications and computationally intense tasks occur on the back end of system 100, with visual refreshes to the GUI of each desk 110, 120 over pre-determined time periods.

Referring back to FIG. 2, an exemplary application of system 100 includes the use of external audio/video devices, such as, for example, a microscope equipped with digital display, such as, for example, an MW1-HD2 Digital Student Microscope (not shown), sold by Microscope World of Carlsbad, Calif. In step 216, the microscope can be placed on student desk 110b and connected to desk 110b, such as, for example, via a USB connection (not shown) built into desk 110b. As the student at desk 110b manipulates the microscope, in step 218, desk 110b transmits images over network 132 so that each desk 110a, 110c-110p, 120 displays the same visual display as viewed by the student at desk 110b. With the microscope on desk 110b, icons or displays on desk might otherwise be covered by the microscope. Desk 110b senses the size and shape of the microscope by reacting to the pressure exerted on desk 110b by the microscope and determining the perimeter of the microscope. Desk 110b then manipulates displays to the extent possible around the microscope so that the displays are visible around the periphery of the microscope. If required to show the displays, the displays may be shrunk to fit around the periphery of the microscope.

Optionally, if multiple microscopes are used, each on a separate desk 110a-110p, teacher desk 120 can present what multiple microscopes see simultaneously. Teacher desk displays a thumbnail of the microscope view from each desk 110a-111p. When the teacher hovers over or clicks on a thumbnail, that view enlarges to enable the teacher to see what that particular microscope is displaying.

Desks 110, 120 can be manipulated by touch to drag or move icons across a respective screen, and to zoom or minimize a graphic. Touch gestures can be accelerated, causing a window to increase in size faster than the separation distance between two points (e.g. a 2× pinch to zoom ratio),

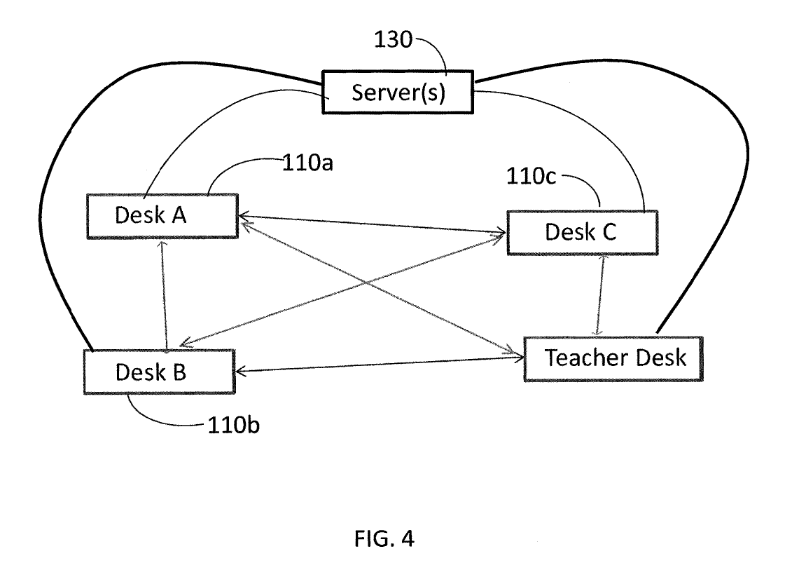

It students are to work together on a group project, a teacher can assign a group of student desks, such as, for example 110a-110c to a “cluster” for that particular group project. In the cluster, student desks 110a-110c can communicate directly with each other and can each access files related to the project that are located in a “group project” folder. As shown in FIG. 4, desks 110a-110c, after having been assigned to a group through teacher desk 112, can communicate directly with each other as well as with teacher desk 120. In the event that a particular desk, such as, for example, desk 110b, cannot, for some reason, communicate directly with server 130, desk 110b can indirectly communicate with server 130 by using peer-to-peer connections through any one or several of desks 110a, 110c, or 120.

The teacher can assign particular desks to a group by tapping on the “Assign Group” icon, causing all of the unassigned student desks 110a-110p to blink. As the teacher taps on each desired desk icon, that particular icon stops blinking. After the teacher has selected the desired desk icons and desires to close the group, the teacher double taps on the “Assign Group” icon, which closes the group and assigns all of the student desks in that group to a particular color. The teacher repeats this process until all of student desks 110a-110p are assigned to a group. All of the desks in a particular group are assigned to a particular color, with no group being assigned the same color. If a student in the group is working from a different location, such as, for example, home, and is logged in as outside party 150, system 100, upon reading the student's login information, treats outside party 150 as if the student is at his/her desk in the class room.

Teacher desk 120 may also include an icon menu 165 that provides a plurality of icons 162, 166-180 from which the teacher can select to display associated information on desk 120. For example, clicking on “students” icon 162 generates overhead view 164 shown in FIG. 3.

Desk 110 can be used to directly take a test. Test questions can be displayed on desk 110. A stylus or other writing implement can be used to write answers directly on desk 110. Character recognition software, such as, for example,

Cuneiform and Tesseract, may be used. During testing, the screen of desk 110 changes the light direction emanating from desk 110 so that on a person sitting directly in front of and looking overhead at desk 110 can see the screen can clearly see the screen, but a person looking at desk 110 from the side cannot see the screen. An exemplary method of doing so is to use a polarizing filter over the screen, which is well known to those in the optical arts.

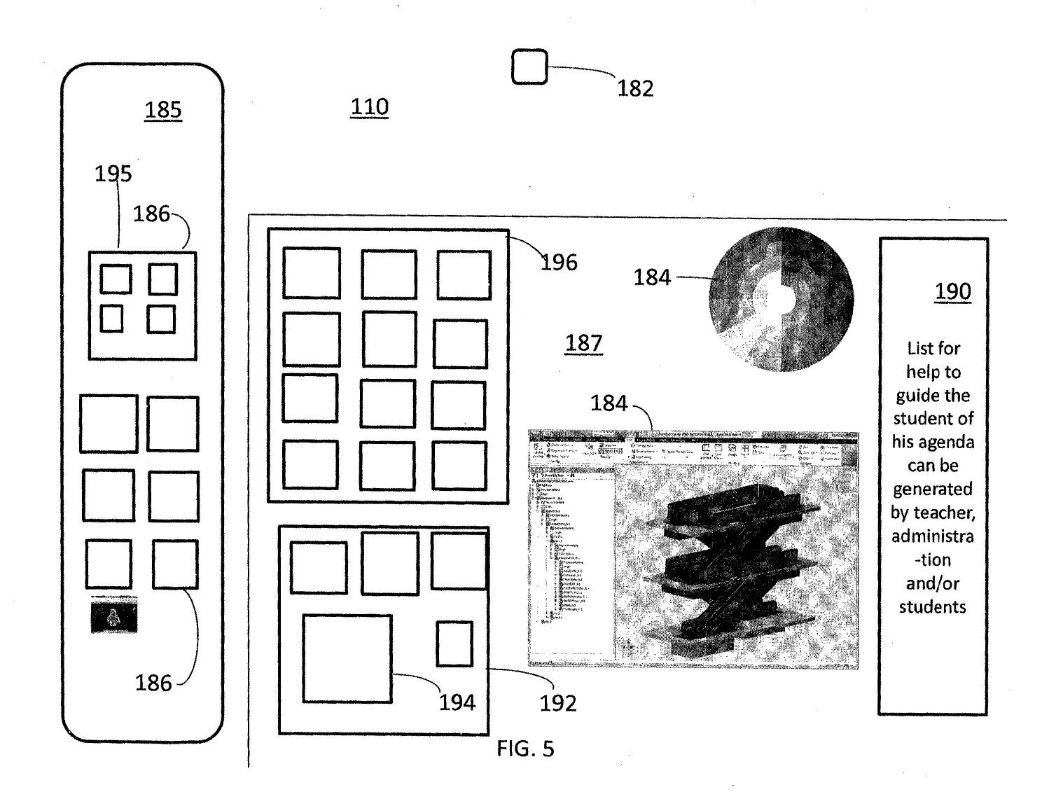

Additionally, as shown in FIG. 5, a camera 182 can be incorporated into desk 110. Camera 182 can be used to scan the eyes and face of the person sitting at desk 110. If the user looks away from the screen of desk 110, the light from the screen dims.

Optionally, system 100 may provide the ability to use a paintbrush to draw/paint on a desk 110. A color wheel 184 of desk 110 shows the selected color in the center of the wheel 184. Clicking on that color updates the color that is being used on desk 110.

Other features of desk 110 include a plurality of tiles 186 in an “app” section 185 that can be “live”, similar to known tiles, such as displayed in the Windows 8 software. A tile 186 can glow to get the student's attention. A tile may glow to show that something needs to be addressed immediately, important system actions are occurring, or a background task has finished. Some examples are when a teacher notifies students, when they receive new documents, or emails that are marked with the highest priority.

Tapping on a particular tile 186 results in desk 110 performing a particular action. For example, if a tile 186 represents a CAD program, such as CAD program 184, then tapping on that tile will generate CAD program 184 on a main portion 187 of desktop 110. When CAD program 184 is present on main portion 187, then the associated tile 186 disappears from app section 185. When CAD program 184 is “closed”, the tile 186 representing the CAD program reappears in app section 185. If a tile 186 represents a live app, then action in the app can be displayed within the tile 186. CAD program 184 (or other app represented on main portion 187) can be an app that is live streaming from a separate server (not shown).

A window 190 can provide a help list generated by a teacher, school administration, or other students. The description of the help is associated with the particular tile 186 that is “open” on main portion 187 of desktop 110.

When the student is working on projects with other students as described above, all of the desktops of the other students are provided, as indicated by icons 192. The largest window, in this instance, window 194, can be the window that is associated with the student whose desk is presently in control or in the lead for the group.

Block 195 displays a snapshot of apps that are accessible to the student. Clicking on block 195 generates block 196, which displays all of those apps on main portion 187. Then, by clicking on an individual block within block 196, an app, such as is shown as CAD program 184, expands and becomes available to the student.

In an exemplary embodiment, each desk 110, 120 may include a docking port 112 (shown schematically in FIG. 3) that allows a portable device, such as, for example, and iPad (not shown) to be docked to docking port 118 and be connected to system 100. The portable device would then act as the desktop, with all of the functionality of desk 110.

While an exemplary embodiment of the present invention is described as being used in a scholastic environment, those skilled in the art will recognize that the present invention can be used in other environments, such as, for example, in a work environment, thereby allowing an employee to sit at any desk and to “login” at the desk so that the employee can access files and capabilities associated with him/her.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An integrated desk system comprising:
an electronic network;
a plurality of student desks connected to the electronic network, each of the plurality of student desks having a student touchscreen, each student touchscreen including a plurality of displays, each of the plurality of student desks having access to only others of the plurality of student desks;
a teacher desk connected to the electronic network, the teacher desk having a teacher touchscreen and access only to each of the plurality of student desks; and
an administrator desk connected to the electronic network, the administrator desk having access to the teacher desk, and each of the plurality of student desks.

2. The integrated desk system according to claim 1, wherein each of the plurality of student desks comprises an identification card reader, the identification card reader adapted to login a student to one of the plurality of student desks.

3. The integrated desk system according to claim 2, wherein the teacher desk comprises a screen having a plurality of icons, each icon representing one of the plurality of student desks, the icon presenting a first indication if a student is not logged into one of the plurality of student desks and presenting a second indication if the student is logged into the one of the plurality of student desks.

4. The integrated desk system according claim 3, wherein the teacher touchscreen is adapted to cluster a subset of the plurality of login student desks in a group.

5. The integrated desk system according to claim 4, wherein each student touchscreen displays a reduced view of the student touchscreen of each of the remaining students in the subset.

6. The integrated desk system according to claim 1, wherein the teacher touchscreen is adapted to display the student touchscreen.

7. The integrated desk system according to claim 1, further comprising a microscope insertable on each of the plurality of student touchscreens and releasably connectable to the electronic network through the student desk.

8. The integrated desk system according to claim 7, further comprising an image generated by the microscope transmitted from the student desk, across the electronic network, to the remainder of the student desks.

9. The integrated desk system according to claim 7, wherein, when the microscope is inserted on the student touchscreen, the plurality of displays are visible around a periphery of the microscope.

10. The integrated desk system according to claim 7, wherein the teacher touchscreen displays the image generated by the microscope from each of the plurality of student touchscreens.

11. The integrated desk system according to claim 1, wherein each student desk comprises a polarizing filter, and wherein each student desk is operable in a test mode such that, during the test mode, each student touchscreen is polarized to prevent a side view of the student touchscreen.

12. The integrated desk system according to claim 1, wherein each student desk comprises a camera such that the camera is adapted to scan the face of a user at the student desk, and wherein, when the camera detects the user looking away from the touchscreen, light generated by the touchscreen is reduced.

13. The integrated desk system according to claim 1, wherein each of the plurality of student desks are in a room associated with a teaching subject and wherein each of the plurality of student desks as a restriction to enable the student desks to access only features associated with the teaching subject.

14. The integrated desk system according to claim 13, wherein the teacher desk in the room is configured to override the restriction.

15. An integrated desk system comprising:
an electronic network;
a plurality of lower level desks connected to the electronic network, each of the plurality of lower level desks having a lower level touchscreen, each lower level touchscreen including a plurality of displays, each of the plurality of lower level desks having access to only others of the plurality of lower level desks;
an upper level desk connected to the electronic network, the upper level desk having a upper level touchscreen and access only to each of the plurality of lower level desks; and
an administrator desk connected to the electronic network, the administrator desk having access to the upper level desk, and each of the plurality of lower level desks.

16. The integrated desk system according to claim 15, further comprising an authorization level associated with each of the lower level desks, the upper level desk, and the administrator desk.
